(19) United States
(12) Patent Application Publication
(10) Pub. No.: US 2005/0141425 A1
(43) Pub. Date: Jun. 30, 2005

(54) Method, system, and program for managing message transmission through a network

(76) Inventor: Christopher T. Foulds, Austin, TX (US)

Correspondence Address: KONRAD RAYNES & VICTOR, LLP, 315 S. BEVERLY DRIVE, # 210, BEVERLY HILLS, CA, 90212, US

(21) Appl. No.: 10/746,162

(22) Filed: Dec. 24, 2003

(51) Int. Cl. H04L 12/28

(52) U.S. Cl. 370/235

(57) ABSTRACT

Provided are a method, system, and program for managing message transmission from a source to a destination through a network. The host imposes a message segment limit which limits the number of message segments which any one connection can transmit at a time. Once a message segment limit is reached for the message being transmitted, the connection releases the transmission resources and permits another connection to transmit message segments of a message until the message segment limit is reached again. Each connection is permitted to resume transmitting segments of the message in additional limited intervals until the message transmission is completed.

### BACKGROUND OF THE INVENTION

1. Field of the Invention

The present invention relates to a method, system, and program for managing data transmission through a network.

2. Description of Related Art

In a network environment, a network adapter on a host computer, such as an Ethernet controller, Fibre Channel controller, etc., will receive Input/Output (I/O) requests or responses to I/O requests initiated from the host. Often, the host computer operating system includes a device driver to communicate with the network adapter hardware to manage I/O requests to transmit over a network. The host computer may also implement a protocol which packages data to be transmitted over the network into packets, each of which contains a destination address as well as a portion of the data to be transmitted. Data packets received at the network adapter are often stored in an available allocated packet buffer in the host memory. A transport protocol layer can process the packets received by the network adapter that are stored in the packet buffer, and access any I/O commands or data embedded in the packet.

For instance, the computer may implement the Transmission Control Protocol (TCP) and Internet Protocol (IP) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source. Another protocol, Remote Direct Memory Access (RDMA) establishes a higher level connection and permits, among other operations, direct placement of data at a specified memory location at the destination.

A “message” comprising a plurality of data packets can be sent from the connection established between the source and a destination. Depending upon the size of the message, the packets of a message might not be sent all at once in one continuous stream. Instead, the message may be subdivided into “segments” in which one segment comprising one or more packets may be dispatched at a time. The message may be sent in a send loop function such as tcp_output, for example, in which a message segment can be sent when the send function enters a send loop.

A device driver, application or operating system can utilize significant host processor resources to handle network transmission requests to the network adapter. One technique to reduce the load on the host processor is the use of a TCP/IP Offload Engine (TOE) in which TCP/IP protocol related operations are implemented in the network adapter hardware as opposed to the device driver or other host software, thereby saving the host processor from having to perform some or all of the TCP/IP protocol related operations. The transport protocol operations include packaging data in a TCP/IP packet with a checksum and other information, and unpacking a TCP/IP packet received from over the network to access the payload or data.

FIG. 1 illustrates a stream 10 of TCP/IP packets which are being sent from a source host to a destination host in a TCP connection. The stream 10 may include one or more messages, each of which may include one or more segments, the size of which can vary, depending upon the size of the message and other factors.

In the TCP protocol as specified in the industry accepted TCP RFC (request for comment), each byte of data (including certain flags) of a packet is assigned a unique sequence number. As each packet is successfully sent to the destination host, an acknowledgment is sent by the destination host to the source host, notifying the source host by packet byte sequence numbers of the successful receipt of the bytes of that packet. Accordingly, the stream 10 includes a portion 12 of packets which have been both sent and acknowledged as received by the destination host. The stream 10 further includes a portion 14 of packets which have been sent by the source host but have not yet been acknowledged as received by the destination host. The source host maintains a TCP Unacknowledged Data Pointer 16 which points to the sequence number of the first unacknowledged sent byte. The TCP Unacknowledged Data Pointer 16 is stored in a field 17a, 17b . . . 17n (FIG. 3) of a Protocol Control Block 18a, 18b . . . 18n, each of which is used to initiate and maintain one of a plurality of associated TCP connections between the source host and one or more destination hosts.

The capacity of the packet buffer used to store data packets received at the destination host is generally limited in size. In accordance with the TCP protocol, the destination host advertises how much buffer space it has available by sending a value referred to herein as a TCP Window indicated at 20 in FIG. 1. Accordingly, the source host uses the TCP Window value to limit the number of outstanding packets sent to the destination host, that is, the number of sent packets for which the source host has not yet received an acknowledgment. The TCP Window value for each TCP connection is stored in a field 21a, 21b . . . 21n of the Protocol Control Block 18a, 18b . . . 18n which controls the associated TCP connection.

For example, if the destination host sends a TCP Window value of 128 KB (kilobytes) for a particular TCP connection, the source host will according to the TCP protocol, limit the amount of data it sends over that TCP connection to 128 KB until it receives an acknowledgment from the destination host that it has received some or all of the data. If the destination host acknowledges that it has received the entire 128 KB, the source host can send another 128 KB. On the other hand, if the destination host acknowledges receiving only 96 KB, for example, the host source will send only an additional 32 KB over that TCP connection until it receives further acknowledgments.

A TCP Next Data Pointer 22 stored in a field 23a, 23b . . . 23n of the associated Protocol Control Block 18a, 18b . . . 18n, points to the sequence number of the next byte to be sent to the destination host. A portion 24 of the datastream 10 between the TCP Next Data Pointer 22 and the end 28 of the TCP Window 20 represents packets which have not yet been sent but are permitted to be sent under the TCP protocol without waiting for any additional acknowledgments because these packets are still within the TCP Window 20 as shown in FIG. 1. A portion 26 of the datastream 10 which is outside the end boundary 28 of the TCP Window 20, is typically not permitted to be sent under the TCP protocol until additional acknowledgments are received.

As the destination host sends acknowledgments to the source host, the TCP Unacknowledged Data Pointer 16 moves to indicate the acknowledgment of bytes of additional packets for that connection. The beginning boundary 30 of the TCP Window 20 shifts with the TCP Unacknowledged Data Pointer 16 so that the TCP Window end boundary 28 also shifts so that additional packets may be sent for the connection.

In one system, as described in copending application Ser. No. 10/663,026, filed Sep. 15, 2003, entitled “Method, System and Program for Managing Data Transmission Through a Network” and assigned to the assignee of the present application, a computer when sending data over a TCP connection can impose a Virtual Window 200 (FIG. 2) which can be substantially smaller than the TCP Window provided by the destination host of the TCP connection. When the TCP Next Data Pointer 22 reaches the end boundary 202 of the Virtual Window 200, the host source stops sending data over that TCP connection even though the TCP Next Data Pointer 22 has not yet reached the end boundary 28 of the TCP Window 20. As a consequence, other connections are provided the opportunity to utilize the resources of the computer 102 such that the resources may be shared more fairly.

Notwithstanding, there is a continued need in the art to improve the performance of connections.

### BRIEF DESCRIPTION OF THE DRAWINGS

Referring now to the drawings in which like reference numbers represent corresponding parts throughout:

FIG. 1 illustrates a stream of data being transmitted in accordance with the prior art TCP protocol;

FIG. 2 illustrates a send resource management technique;

FIG. 3 illustrates prior art Protocol Control Blocks in accordance with the TCP protocol;

FIG. 4 illustrates one embodiment of a computing environment in which aspects of the invention are implemented;

FIG. 5 illustrates a prior art packet architecture;

FIG. 6 illustrates one embodiment of operations performed to manage a transmission of data in accordance with aspects of the invention;

FIGS. 7A and 7B illustrate one embodiment of operations performed to manage a transmission of data in accordance with aspects of the invention;

FIG. 8 illustrates one embodiment of a data structure to store information used to manage transmission of data in accordance with aspects of the invention; and

FIG. 9 illustrates an architecture that may be used with the described embodiments.

### DETAILED DESCRIPTION OF THE ILLUSTRATED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

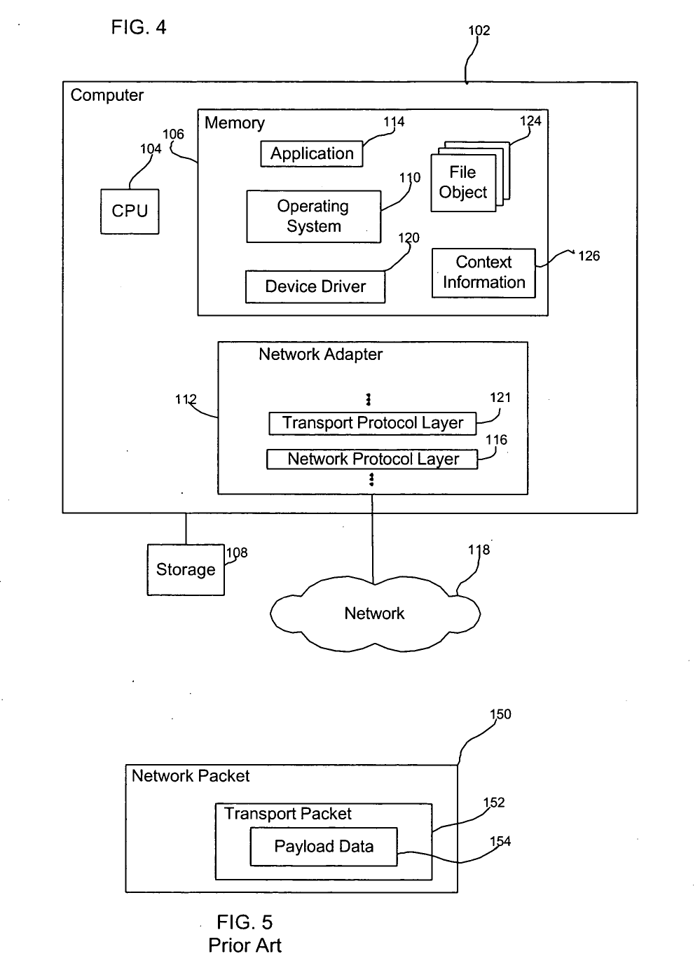

FIG. 4 illustrates a computing environment in which aspects of the invention may be implemented. A computer 102 includes one or more central processing units (CPU) 104 (only one is shown), a volatile memory 106, non-volatile storage 108, an operating system 110, and a network adapter 112. An application program 114 further executes in memory 106 and is capable of transmitting and receiving packets from a remote computer. The computer 102 may comprise any computing device known in the art, such as a mainframe, server, personal computer, workstation, laptop, handheld computer, telephony device, network appliance, virtualization device, storage controller, network controller, etc. Any CPU 104 and operating system 110 known in the art may be used. Programs and data in memory 106 may be swapped into storage 108 as part of memory management operations.

The network adapter 112 includes a network protocol layer 116 to send and receive network packets to and from remote devices over a network 118. The network 118 may comprise a Local Area Network (LAN), the Internet, a Wide Area Network (WAN), Storage Area Network (SAN), etc. The embodiments may be configured to transmit data over a wireless network or connection, such as wireless LAN, Bluetooth, etc. In certain embodiments, the network adapter 112 and various protocol layers may implement the Ethernet protocol including Ethernet protocol over unshielded twisted pair cable, token ring protocol, Fibre Channel protocol, Infiniband, Serial Advanced Technology Attachment (SATA), parallel SCSI, serial attached SCSI cable, etc., or any other network communication protocol known in the art.

A device driver 120 executes in memory 106 and includes network adapter 112 specific commands to communicate with a network controller of the network adapter 112 and interface between the operating system 110, applications 114 and the network adapter 112. The network controller can implement the network protocol layer 116 and can control other protocol layers including a data link layer and a physical layer which includes hardware such as a data transceiver. In an embodiment employing the Ethernet protocol, the data transceiver could be an Ethernet transceiver.

In certain implementations, the network controller of the adapter 112 includes a transport protocol layer 121 as well as the network protocol layer 116 and other protocol layers. For example, the network controller of the network adapter 112 can implement a TCP/IP offload engine (TOE), in which many transport layer operations can be performed within the offload engines of the transport protocol layer 121 implemented within the network adapter 112 hardware or firmware, as opposed to the device driver 120, operating system 110 or an application 114.

The network layer 116 handles network communication and provides received TCP/IP packets to the transport protocol layer 121. The transport protocol layer 121 interfaces with the device driver 120, or operating system 110 or application 114 and performs additional transport protocol layer operations, such as processing the content of messages included in the packets received at the network adapter 112 that are wrapped in a transport layer, such as TCP and/or IP, the Internet Small Computer System Interface (iSCSI), Fibre Channel SCSI, parallel SCSI transport, or any transport layer protocol known in the art. The transport offload engine 121 can unpack the payload from the received TCP/IP packet and transfer the data to the device driver 120, operating system 110 or an application 114.

In certain implementations, the network controller and network adapter 112 can further include an RDMA protocol layer as well as the transport protocol layer 121. For example, the network adapter 112 can implement an RDMA offload engine, in which RDMA layer operations are performed within the offload engines of the RDMA protocol layer implemented within the network adapter 112 hardware, as opposed to the device driver 120, operating system 110 or an application 114.

Thus, for example, an application 114 transmitting messages over an RDMA connection can transmit the message through the device driver 120 and the RDMA protocol layer of the network adapter 112. The data of the message can be sent to the transport protocol layer 121 to be packaged in a TCP/IP packet before transmitting it over the network 118 through the network protocol layer 116 and other protocol layers including the data link and physical protocol layers.

The memory 106 further includes file objects 124, which also may be referred to as socket objects, which include information on a connection to a remote computer over the network 118. The application 114 uses the information in the file object 124 to identify the connection. The application 114 would use the file object 124 to communicate with a remote system. The file object 124 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 126 comprises a data structure including information the device driver 120, operating system 110 or an application 114, maintains to manage requests sent to the network adapter 112 as described below.

FIG. 5 illustrates a format of a network packet 150 received at or transmitted by the network adapter 112. A message or message segment may include one or many such packets 150. The network packet 150 is implemented in a format understood by the network protocol 114 such as the IP protocol. The network packet 150 may include an Ethernet frame that would include additional Ethernet components, such as a header and error checking code (not shown). A transport packet 152 is included in the network packet 150. The transport packet 152 is capable of being processed by a transport protocol layer 121, such as the TCP protocol. The packet 152 may be processed by other layers in accordance with other protocols including Internet Small Computer System Interface (iSCSI) protocol, Fibre Channel SCSI, parallel SCSI transport, etc. The transport packet 152 includes payload data 154 as well as other transport layer fields, such as a header and an error checking code. The payload data 154 includes the underlying content being transmitted, e.g., commands, status and/or data. The driver 120, operating system 110 or an application 114 may include a layer, such as a SCSI driver or layer, to process the content of the payload data 154 and access any status, commands and/or data therein.

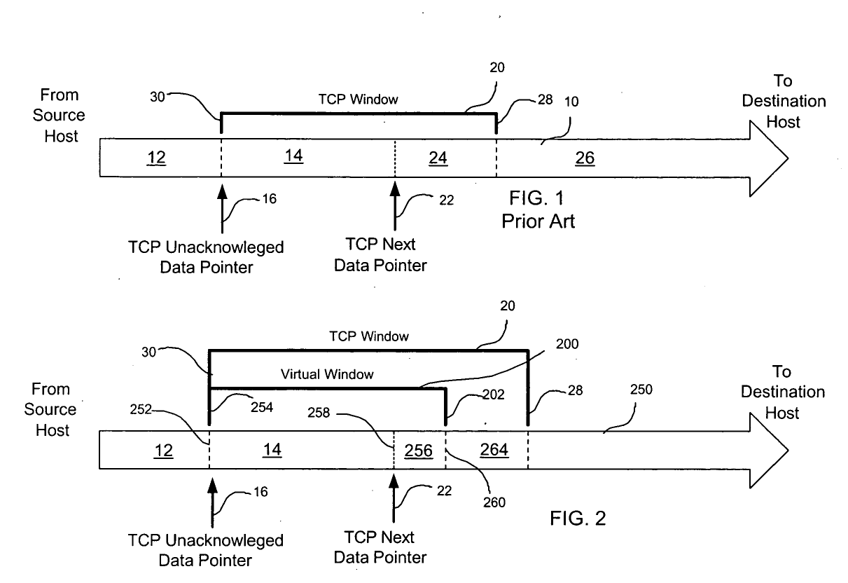

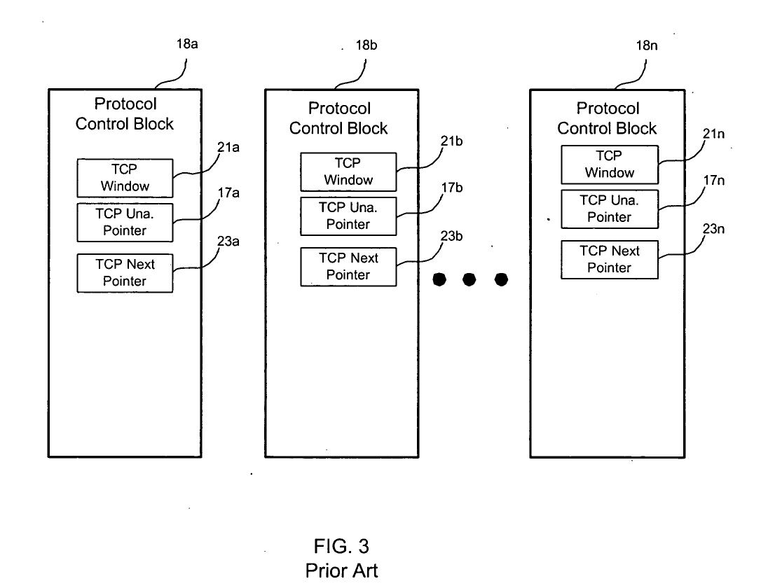

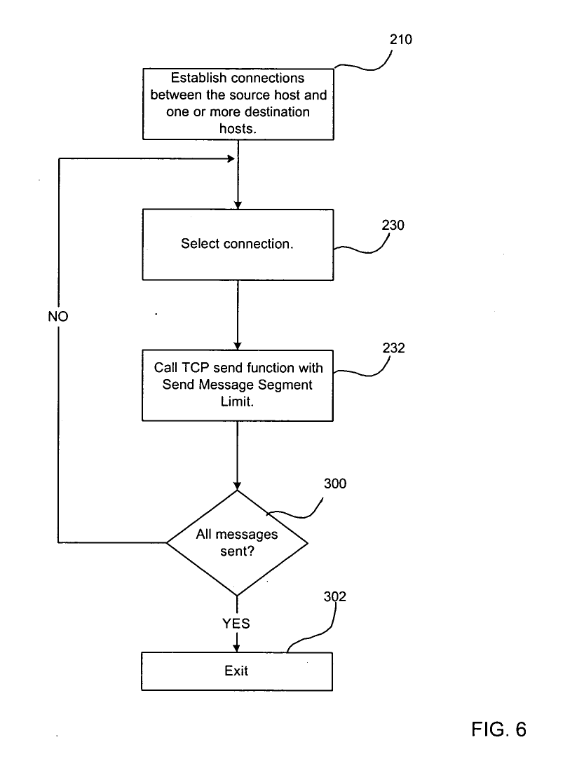

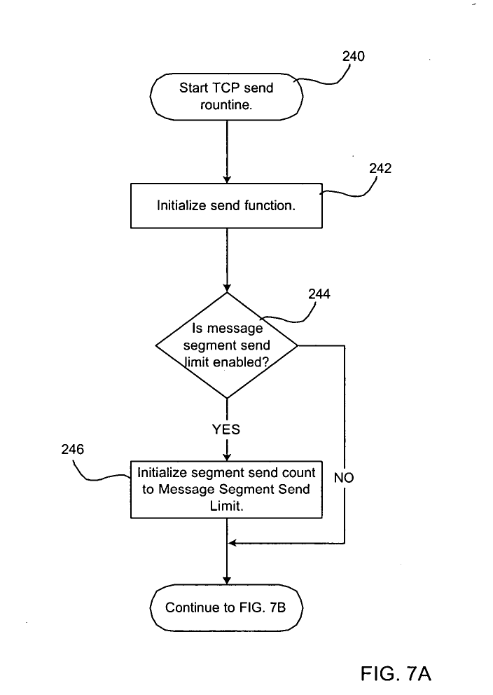

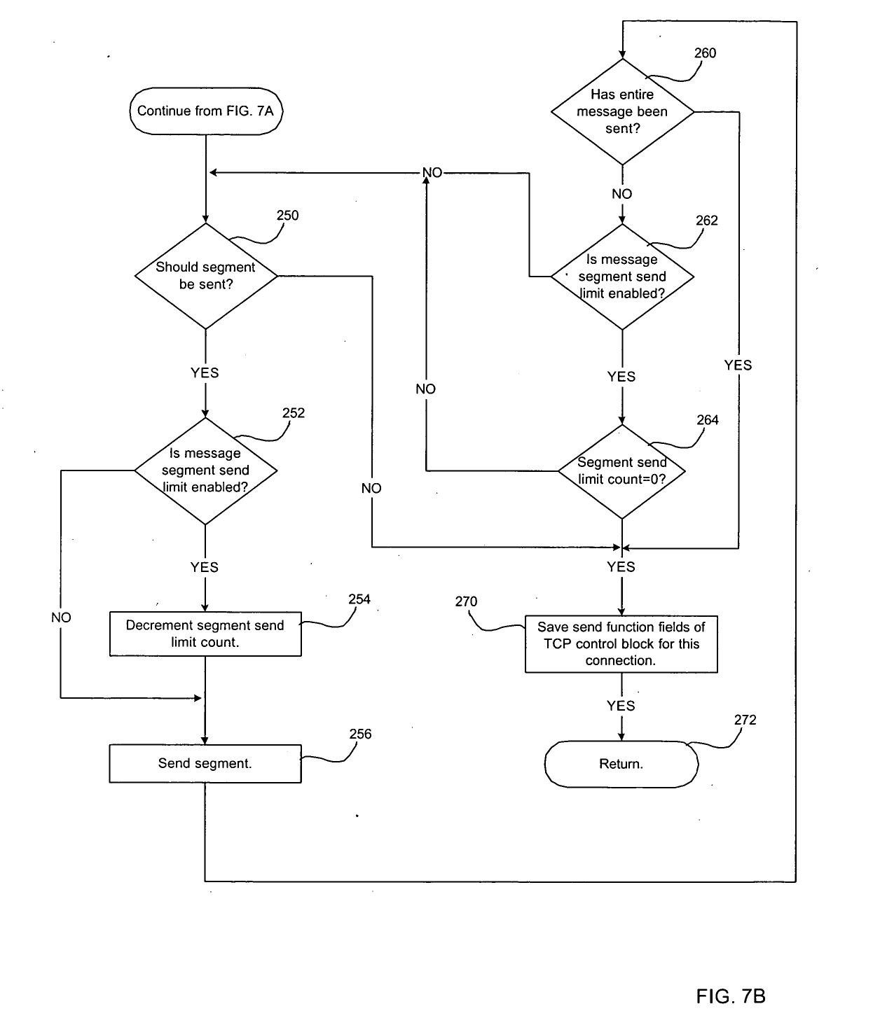

If a particular TCP connection of the source host is accorded a relatively large TCP window 20 (FIG. 1) when sending data over the TCP connection to a destination host, it is appreciated that the TCP connection having the large TCP window can continue sending data in a manner which uses up the resources of the source host to the exclusion of other TCP connections of the source host. As a consequence, the other TCP connections of the source host may be hindered from sending data. In one implementation as shown in FIGS. 6-7B, the computer 102 when sending data over a TCP connection imposes a programmable Message Segment Send Limit such that the number of successive executions of a send loop of the send function is programmable. In one embodiment, a message segment can be sent each time a send loop of the send function is executed. The programmable Message Segment Send Limit may be used to control the number of successive executions of the send loop and hence control the number of successive message segments sent. As consequence, the amount of time that any one connection can transmit may be controlled as well. In this manner, other connections can be afforded the opportunity to utilize the resources of the computer 102 such that the resources may be shared more fairly.

In one embodiment, as discussed below, the programmable Message Segment Send Limit may be globally programmed so that each connection is allowed the same number of executions of the send loop. Alternatively, a different Message Segment Send Limit may be programmed for each connection. In this manner, each connection may be given the same priority or alternatively, each connection may be given a weighted priority. This weighted priority may be provided by, for example, assigning different Message Segment Send Limits to various connections.

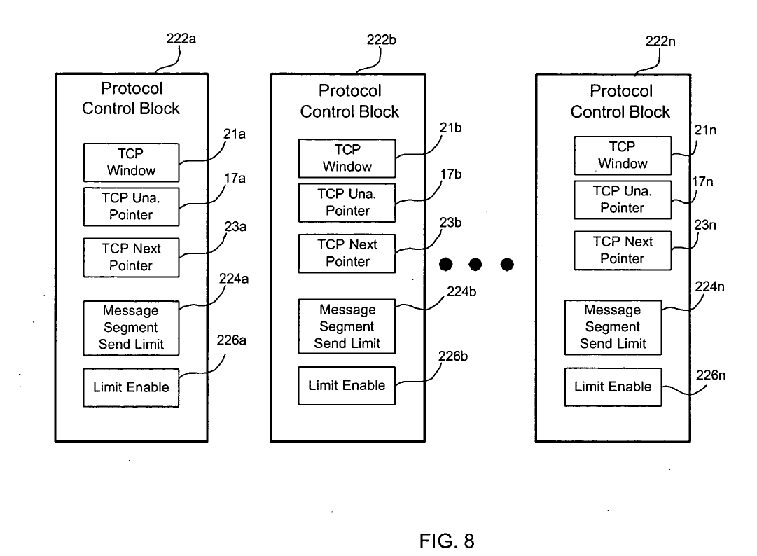

FIGS. 6-7B illustrates message transmission operations using a programmable Message Segment Send Limit to distribute the data transmission resources of the computer 102. These operations may be implemented in hardware, software, firmware or any combination thereof. In response to a request, typically by a software application 114, a plurality of TCP connections are established (block 210) between the computer 102 and one or more destination hosts. In establishing the TCP connection, a Protocol Control Block such as one of the Protocol Control Blocks 222a, 222b . . . 222n (FIG. 8) is populated in a manner similar to the Protocol Control Blocks 18a, 18b . . . 18n of FIG. 2. Each Protocol Control Block 222a, 222b . . . 222n has a field 17a, 17b . . . 17n for storing the TCP Unacknowledged Data Pointer 16, a field 21a, 21b . . . 21n for storing the TCP Window, and a field 23a, 23b . . . 23n for storing a TCP Next Pointer of the associated TCP connection in accordance with the TCP RFC.

In this implementation, a programmable Message Segment Send Limit is stored in a field 224a, 224b . . . 224n of the associated Protocol Control Block 222a, 222b. . . 222n for each connection. In another aspect, the Message Segment Send Limit programmed for each connection may be selectively enabled for each connection. Thus, a Limit Enable is stored in a field 226a, 226b . . . 226n of the associated Protocol Control Block 222a, 222b . . . 222n for each connection.

To begin transmitting the messages of the various connections which have been established, a first connection is selected (block 230). The particular connection which is selected may be selected using a variety of techniques. In one embodiment, the connections may be assigned different levels of priority. Other techniques may be used as well.

A suitable send function is called (block 232) or initiated for the selected connection. In the illustrated embodiment, the send function may operate substantially in accordance with the TCP_Output function as implemented by the Berkeley Software Distribution (BSD). However, the send function of the illustrated embodiment has been modified as set forth in FIGS. 7A and 7B to utilize the programmable Message Segment Send Limit to limit the number of successive segments which are sent during the interval of a call to the send function for the selected connection.

The interval of a send function is started (block 240, FIG. 7A) in response to the function call (block 232, FIG. 6). The send function is initialized (block 242). This initialization may include, for example, setting the congestion window to one segment to force slow start if the connection has been idle for a period of time. In one aspect, a determination (block 244) is made as to whether the Message Segment Send Limit programmed for the connection has been enabled. Thus, the Limit Enable stored in the field 226a, 226b . . . 226n of the associated Protocol Control Block 222a, 222b . . . 222n for the selected connection is examined. In one embodiment, the Limit Enable stored in the associated Protocol Control Block 222a, 222b . . . 222n for the selected connection may be stored in a register or other suitable storage for the send function being executed.

If the limiting of sending of message segments has been enabled as indicated by the Limit Enable variable, a segment send count is initialized (block 246) to the value of the Message Segment Send Limit programmed for the selected connection as indicated by the field 224a, 224b . . . 224n of the associated Protocol Control Block 222a, 222b . . . 222n for the selected connection. If the limiting of sending of message segments has not been enabled, the initialization of the segment count is skipped as shown in FIG. 7A.

During this interval of FIGS. 7A, 7B, in which the send function is executed, a determination (block 250, FIG. 7B) is made as to whether a segment of the message should be sent. Various conditions may be considered in a determination of whether to send the next segment. For example, it may be determined whether there is any unused send window left. If the TCP Next Data Pointer 23a, 23b . . . 23n has reached the end boundary of a send window, additional sending of packets for that connection may not be permitted. Other conditions may be considered as well such as the amount of send window available, whether or not the Nagle algorithm is enabled, whether or not the retransmission timer has expired, and whether or not various flags are set.

If conditions are such that a segment can be sent, a determination (block 252) is made again as to whether the Message Segment Send Limit programmed for the connection has been enabled. If the limiting of sending of message segments during the interval has been enabled as indicated by the Limit Enable variable, the segment send count previously initialized (block 246) to the value of the Message Segment Send Limit is decremented (block 254) for the selected connection. If the limiting of sending of message segments has not been enabled, the decrementing the segment send count is skipped as shown in FIG. 7B.

A segment of the message of the selected connection is then sent (block 256). Upon sending the packet or packets of the message segment, the TCP Next Data Pointer 23a, 23b . . . 23n of the associated Protocol Control Block 222a, 222b . . . 222n for the selected connection is updated to point to the first byte of the next message segment to be sent.

A determination (block 260) is made as to whether the entire message (in this example, all the message segments of the message) has been sent. If not, a determination (block 262) is made again as to whether the Message Segment Send Limit programmed for the connection has been enabled. If the limiting of sending of message segments has been enabled as indicated by the Limit Enable variable, a determination (block 264) is made as to whether the segment send count has reached zero, that is, whether the number of successive message segments sent in this interval of execution of the send function has reached the maximum number as indicated by the Message Segment Send Limit.

If it is determined (block 264) that the segment sent count has not reached zero, that is, that the maximum number of successive message segments as indicated by the Message Segment Send limit has not yet been sent in this execution of the send function, the segment sending interval is continued in which successive additional message segments are sent (block 256) and the segment send limit count is decremented (block 254) for each message segment sent until either conditions do not permit (block 250) the sending of another message segment, the entire message has been sent (block 260), or the number of successive message segments sent in this execution interval of the send function has reached (block 264) the maximum number as indicated by the Message Segment Send Limit.

Once conditions do not permit (block 250) the sending of another message segment, or the number of successive message segments sent in this execution of the send function has reached (block 264) the maximum number as indicated by the Message Segment Send Limit, or the entire message has been sent (block 260), the message segment sending interval ends and the appropriate send function fields of the Protocol Control Block 222a, 222b . . . 222n for the selected connection are saved (block 270) and the process returns (block 272) from the called send function. Once the entire message has been sent (block 260), the process returns (block 272) from the called send function.

Although the entire message may have not been sent (block 260), and although conditions may still permit (block 250) the sending of another message segment, once the number of successive message segments sent in this execution interval of the send function has reached (block 264) the maximum number as indicated by the Message Segment Send Limit, further sending of message segments is suspended at this time for the selected connection to permit other connections to have access to the send resources of the send host. Since the entire message for the selected connection has not been sent, the appropriate send function fields of the Protocol Control Block 222a, 222b. . . 222n for the selected connection are saved (block 270) and the process returns (block 270) from the called send function.

Upon returning from the called send function, a determination (block 300, FIG. 6) is made as to whether all the messages have been sent. If not, another connection is selected (block 230) in accordance with a suitable selection process. As previously mentioned, the next connection may be selected using a variety of techniques including ones in which the connections may be assigned different levels of priority. Other techniques may be used as well.

The send function is then called again (block 232) to start another message segment sending interval in which message segments of the message of the selected connection are sent. Again, the send function may utilize the programmable Message Segment Send Limit to limit the number of successive segments which are sent during the interval of the send function call for the next selected connection if enabled for that connection. Upon the return from the send function call when the interval of the send function call is ended, connections are successively selected (block 230) and the send function is called (block 232) and new message segment sending intervals entered for each selected connection until all the messages have been sent (block 300) which permits the process to exit (block 302).

### Additional Embodiment Details

The described techniques for processing requests directed to a network card may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain operations were described as being performed by the device driver 120, or by one or more of the protocol layers of the network adapter 112. In alterative embodiments, operations described as performed by the device driver 120 may be performed by the network adapter 112, and vice versa.

In the described embodiments, various protocol layers and operations of those protocol layers were described. The operations of each of the various protocol layers may be implemented in hardware, firmware, drivers, operating systems, applications or other software, in whole or in part, alone or in various combinations thereof.

In the described embodiments, the packets are transmitted from a network adapter card to a remote computer over a network. In alternative embodiments, the transmitted and received packets processed by the protocol layers or device driver may be transmitted to a separate process executing in the same computer in which the device driver and transport protocol driver execute. In such embodiments, the network card is not used as the packets are passed between processes within the same computer and/or operating system.

In certain implementations, the device driver and network adapter embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. In alternative implementations, the network adapter embodiments may be included in a system that does not include a storage controller, such as certain hubs and switches.

In certain implementations, the device driver and network adapter embodiments may be implemented in a computer system including a video controller to render information to display on a monitor coupled to the computer system including the device driver and network adapter, such as a computer system comprising a desktop, workstation, server, mainframe, laptop, handheld computer, etc. Alternatively, the network adapter and device driver embodiments may be implemented in a computing device that does not include a video controller, such as a switch, router, etc.

In certain implementations, the network adapter may be configured to transmit data across a cable connected to a port on the network adapter. Alternatively, the network adapter embodiments may be configured to transmit data over a wireless network or connection, such as wireless LAN, Bluetooth, etc.

FIG. 8 illustrates information used to populate Protocol Control Blocks. In alternative implementation, these data structures may include additional or different information than illustrated in the figures.

The illustrated logic of FIGS. 6-7B show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

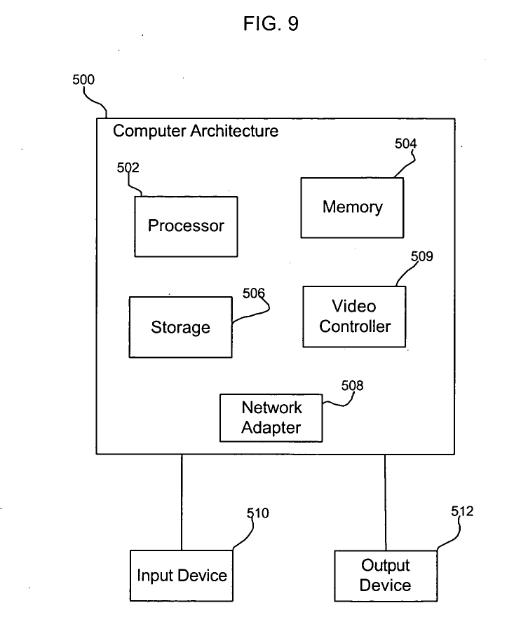

FIG. 9 illustrates one implementation of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a non-volatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor and may be implemented on a separate card or integrated on integrated circuit components mounted on the motherboard. As discussed, certain of the network devices may have multiple network adapters. An input device 510 is used to provide user input to the processor 502, and may include a keyboard, mouse, pen-stylus, microphone, touch sensitive display screen, or any other activation or input mechanism known in the art. An output device 512 is capable of rendering information transmitted from the processor 502, or other component, such as a display monitor, printer, storage, etc.

The network adapter 508 may be implemented on a network card, such as a Peripheral Component Interconnect (PCI) card or some other I/O card, or on integrated circuit components mounted on the motherboard or in software.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method for sending data, comprising:
sending a plurality of message segments of a first message in a first interval;
comparing the number of sent message segments of said first message to a first predetermined message segment limit which is less than the total number of message segments of said first message; and
suspending the sending of said message segments of said first message in said first interval when the number of message segments of said first message sent reaches said first predetermined message segment limit.

2. The method of claim 1 further comprising:
after said suspending the sending of said message segments of said first message in said first interval, sending a plurality of message segments of a second message in a second interval;
comparing the number of message segments of said second message sent in said second interval to a second predetermined message segment limit which is less than the total number of message segments of said second message; and
suspending the sending of said message segments of said second message in said second interval when the number of message segments of said second message sent in said second interval reaches said second predetermined message segment limit.

3. The method of claim 1 further comprising:
after said suspending the sending of said message segments of said second message in said second interval, resuming the sending of a plurality of message segments of said first message in a third interval;
comparing the number of message segments of said first message sent in said third interval to said first predetermined message segment limit; and
suspending the sending of said message segments of said first message in said third interval when the number of message segments of said first message sent in said third interval reaches said first predetermined message segment limit.

4. The method of claim 3 wherein the number of segments of said first predetermined message segment limit is different than the number of segments of said second predetermined message segment limit.

5. The method of claim 3 wherein the number of segments of said first predetermined message segment limit is the same as the number of segments of said second predetermined message segment limit.

6. The method of claim 2 wherein said first interval is initiated by a first call to a message segment send function and said first interval ends upon the return from said first call to said message segment send function.

7. The method of claim 6 wherein said message segment send function is the TCP_Output function.

8. The method of claim 2 further comprising:
establishing a first active connection adapted to send packets of data of said first message between a host and a destination; and
receiving from the destination a first window value representing a first quantity of data packets;
wherein said first predetermined message segment limit represents a quantity of packets less than said first quantity of packets of said first window value.

9. The method of claim 8 wherein the first connection is a Transmission Control Protocol connection between the host and the destination and wherein said first window value is a Transmission Control Protocol send window value.

10. The method of claim 9 further comprising establishing a second Transmission Control Protocol connection adapted to send packets of data of said second message between the host and a destination; and
receiving from the destination of the second connection a second Transmission Control Protocol send window value representing a second quantity of data packets;
wherein each Transmission Control Protocol connection has a Protocol Control Block which stores the associated Transmission Control Protocol send window value and the associated predetermined message segment limit of the connection.

11. The method of claim 10 further comprising enabling said comparing and suspending for each connection in response to an enable field stored in said Protocol Control Block associated with each connection.

12. An article comprising a storage medium, the storage medium comprising machine readable instructions stored thereon to:
send a plurality of message segments of a first message in a first interval;
compare the number of sent message segments of said first message to a first predetermined message segment limit which is less than the total number of message segments of said first message; and
suspend the sending of said message segments of said first message in said first interval when the number of message segments of said first message sent reaches said first predetermined message segment limit.

13. The article of claim 12 wherein the storage medium further comprises machine readable instructions stored thereon to:
after said suspending the sending of said message segments of said first message in said first interval, send a plurality of message segments of a second message in a second interval;
compare the number of message segments of said second message sent in said second interval to a second predetermined message segment limit which is less than the total number of message segments of said second message; and
suspend the sending of said message segments of said second message in said second interval when the number of message segments of said second message sent in said second interval reaches said second predetermined message segment limit.

14. The article of claim 12 wherein the storage medium further comprises machine readable instructions stored thereon to:
after said suspending the sending of said message segments of said second message in said second interval, resume the sending of a plurality of message segments of said first message in a third interval;
compare the number of message segments of said first message sent in said third interval to said first predetermined message segment limit; and
suspend the sending of said message segments of said first message in said third interval when the number of message segments of said first message sent in said third interval reaches said first predetermined message segment limit.

15. The article of claim 14 wherein the number of segments of said first predetermined message segment limit is different than the number of segments of said second predetermined message segment limit.

16. The article of claim 14 wherein the number of segments of said first predetermined message segment limit is the same as the number of segments of said second predetermined message segment limit.

17. The article of claim 13 wherein said first interval is initiated by a first call to a message segment send function and said first interval ends upon the return from said first call to said message segment send function.

18. The article of claim 17 wherein said message segment send function is the TCP_Output function.

19. The article of claim 13 wherein the storage medium further comprises machine readable instructions stored thereon to:
establish a first active connection adapted to send packets of data of said first message between a host and a destination; and
receive from the destination a first window value representing a first quantity of data packets;
wherein said first predetermined message segment limit represents a quantity of packets less than said first quantity of packets of said first window value.

20. The article of claim 19 wherein the first connection is a Transmission Control Protocol connection between the host and the destination and wherein said first window value is a Transmission Control Protocol send window value.

21. The article of claim wherein the storage medium further comprises machine readable instructions stored thereon to:
establish a second Transmission Control Protocol connection adapted to send packets of data of said second message between the host and a destination; and
receive from the destination of the second connection a second Transmission Control Protocol send window value representing a second quantity of data packets;
wherein each Transmission Control Protocol connection has a Protocol Control Block which stores the associated Transmission Control Protocol send window value and the associated predetermined message segment limit of the connection.

22. The article of claim 21 wherein the storage medium further comprises machine readable instructions stored thereon to enable said comparing and suspending for each connection in response to an enable field stored in said Protocol Control Block associated with each connection.

23. A system, comprising:
a memory which includes an operating system;
a processor coupled to the memory;
a network controller;
data storage;
a data storage controller for managing Input/Output (I/O) access to the data storage; and
a device driver executable by the processor in the memory, wherein at least one of the operating system, device driver and the network controller is adapted to:
send a plurality of message segments of a first message in a first interval;
compare the number of sent message segments of said first message to a first predetermined message segment limit which is less than the total number of message segments of said first message; and
suspend the sending of said message segments of said first message in said first interval when the number of message segments of said first message sent reaches said first predetermined message segment limit.

24. The system of claim 23 wherein at least one of the operating system, device driver and the network controller is further adapted to:
after said suspending the sending of said message segments of said first message in said first interval, send a plurality of message segments of a second message in a second interval;
compare the number of message segments of said second message sent in said second interval to a second predetermined message segment limit which is less than the total number of message segments of said second message; and
suspend the sending of said message segments of said second message in said second interval when the number of message segments of said second message sent in said second interval reaches said second predetermined message segment limit.

25. The system of claim 23 wherein at least one of the operating system, device driver and the network controller is adapted to:
after said suspending the sending of said message segments of said second message in said second interval, resume the sending of a plurality of message segments of said first message in a third interval;
compare the number of message segments of said first message sent in said third interval to said first predetermined message segment limit; and
suspend the sending of said message segments of said first message in said third interval when the number of message segments of said first message sent in said third interval reaches said first predetermined message segment limit.

26. The system of claim 25 wherein the number of segments of said first predetermined message segment limit is different than the number of segments of said second predetermined message segment limit.

27. The system of claim 25 wherein the number of segments of said first predetermined message segment limit is the same as the number of segments of said second predetermined message segment limit.

28. The system of claim 24 wherein said first interval is initiated by a first call to a message segment send function and said first interval ends upon the return from said first call to said message segment send function.

29. The system of claim 28 wherein said message segment send function is the TCP_Output function.

30. The system of claim 24 wherein at least one of the operating system, device driver and the network controller is adapted to:
establish a first active connection adapted to send packets of data of said first message between a host and a destination; and
receive from the destination a first window value representing a first quantity of data packets;
wherein said first predetermined message segment limit represents a quantity of packets less than said first quantity of packets of said first window value.

31. The system of claim 30 wherein the first connection is a Transmission Control Protocol connection between the host and the destination and wherein said first window value is a Transmission Control Protocol send window value.

32. The system of claim wherein at least one of the operating system, device driver and the network controller is adapted to:
establish a second Transmission Control Protocol connection adapted to send packets of data of said second message between the host and a destination; and
receive from the destination of the second connection a second Transmission Control Protocol send window value representing a second quantity of data packets;
wherein each Transmission Control Protocol connection has a Protocol Control Block which stores the associated Transmission Control Protocol send window value and the associated predetermined message segment limit of the connection.

33. The system of claim 32 wherein at least one of the operating system, device driver and the network controller is adapted to enable said comparing and suspending for each connection in response to an enable field stored in said Protocol Control Block associated with each connection.

34. The system of claim 23 for use with an unshielded twisted pair cable, said system further comprising an Ethernet data transceiver coupled to said network controller and said cable and adapted to transmit and receive data over said cable.

35. The system of claim 23 further comprising a video controller coupled to said processor.

36. A device for sending a message comprising message segments, the device comprising:
means for sending a plurality of message segments of a first message in a first interval;
means for comparing the number of sent message segments of said first message to a first predetermined message segment limit which is less than the total number of message segments of said first message; and
means for suspending the sending of said message segments of said first message in said first interval when the number of message segments of said first message sent reaches said first predetermined message segment limit.

37. The device of claim 36 wherein:
said sending means has means for, after said suspending the sending of said message segments of said first message in said first interval, sending a plurality of message segments of a second message in a second interval;
said comparing means has means for, comparing the number of message segments of said second message sent in said second interval to a second predetermined message segment limit which is less than the total number of message segments of said second message; and
said suspending means has means for suspending the sending of said message segments of said second message in said second interval when the number of message segments of said second message sent in said second interval reaches said second predetermined message segment limit.

38. The device of claim 36 wherein:
said sending means has means for, after said suspending the sending of said message segments of said second message in said second interval, resuming the sending of a plurality of message segments of said first message in a third interval;
said comparing means has means for, comparing the number of message segments of said first message sent in said third interval to said first predetermined message segment limit; and
said suspending means has means for, suspending the sending of said message segments of said first message in said third interval when the number of message segments of said first message sent in said third interval reaches said first predetermined message segment limit.

39. The device of claim 38 wherein the number of segments of said first predetermined message segment limit is different than the number of segments of said second predetermined message segment limit.

40. The device of claim 38 wherein the number of segments of said first predetermined message segment limit is the same as the number of segments of said second predetermined message segment limit.

41. The device of claim 37 wherein said sending means includes a callable message segment send function software routine and said first interval is initiated by a first call to said message segment send function software routine and said first interval ends upon the return from said first call to said message segment send function software routine.

42. The device of claim 41 wherein said message segment send function software routine is the TCP_Output function.

43. The device of claim 37 further comprising:
means for establishing a first active connection adapted to send packets of data of said first message between a host and a destination; and
means for receiving from the destination a first window value representing a first quantity of data packets;
wherein said first predetermined message segment limit represents a quantity of packets less than said first quantity of packets of said first window value.

44. The device of claim 43 wherein the first connection is a Transmission Control Protocol connection between the host and the destination and wherein said first window value is a Transmission Control Protocol send window value.

45. The device of claim 44 wherein said establishing means has means for establishing a second Transmission Control Protocol connection adapted to send packets of data of said second message between the host and a destination; and
said receiving means has means for receiving from the destination of the second connection a second Transmission Control Protocol send window value representing a second quantity of data packets;
wherein each Transmission Control Protocol connection has a Protocol Control Block which stores the associated Transmission Control Protocol send window value and the associated predetermined message segment limit of the connection.

46. The device of claim 45 wherein each Protocol Control Block associated with a connection has an enable field, said device further comprising means for enabling said comparing means and suspending means for each connection in response to an enable field stored in said Protocol Control Block associated with each connection.
